(19) United States
(12) Patent Application Publication
(10) Pub. No.: US 2025/0178231 A1
(43) Pub. Date: Jun. 5, 2025

(54) PORTABLE CUTTING MACHINE FOR WOODWORKING

(71) Applicant: MAKITA CORPORATION, ANJO-SHI (JP)

(72) Inventors: Yasushi OGURA, Anjo-shi (JP); Takuji KIMURA, Anjo-shi (JP); Takuma MIZUTANI, Anjo-shi (JP)

(21) Appl. No.: 18/944,142

(22) Filed: Nov. 12, 2024

(30) Foreign Application Priority Data
Dec. 5, 2023 (JP) 2023-205224

(51) Int. Cl. B27C 5/10; B25F 5/02

(52) U.S. Cl. CPC B27C 5/10; B25F 5/02

(57) ABSTRACT

A battery mounting part (21) of a portable cutting machine (1), such as a router, holds a battery (3) oriented so that the longitudinal direction (L3) of the battery is at an angle of 70 to 90 degrees with respect to an imaginary plane (K) that contains left and right support members (11, 12) of the portable cutting machine. Consequently, even if batteries having different capacities are mounted on a battery mounting part (21) of the portable cutting machine, the position of the center of gravity of a main body (20) thereof will not differ greatly (or at all) in the left-right direction, and thus the weight balance is preserved and good handling is maintained, regardless of the size and/or weight of the battery that is mounted on the battery mounting part.

### CROSS-REFERENCE

The present application claims priority to Japanese patent application serial number 2023-205224 filed on Dec. 5, 2023, the contents of which are hereby fully incorporated by reference.

### TECHNICAL FIELD

The present disclosure relates to a portable cutting machine for woodworking, such as a router, on which a battery can be mounted.

### BACKGROUND ART

Known portable cutting machines for woodworking, such as rechargeable routers, include, for example, plunge type routers (plunge-base routers), in which a tool main body is supported on a base that is brought into contact with a workpiece, and is movable in the directions towards and away from a workpiece. Plunge type (plunge-base) portable cutting machines for woodworking are disclosed in, for example, JP 2014-148017 A and JP 2018-79632 A. In JP 2014-148017 A, a plunge type (plunge-base) portable cutting machine for woodworking on which two batteries can be mounted as the power supply is disclosed. In JP 2018-79632 A, a plunge type (plunge-base) portable cutting machine for woodworking is disclosed in which, one battery, serving as the power supply, is mounted and removed by being moved in the left-right direction.

### SUMMARY OF THE INVENTION

In embodiments of routers in which batteries having different capacities (sizes, weights) are interchangeably mountable on the router, there is a problem in that, for example, large capacity batteries tend to protrude in the left-right direction and get in the way when gripping (holding) the grip parts (handles) of the router. In addition, there is a problem in that mounting a large capacity battery changes the position of the center of gravity of the router (as compared to a router having a small capacity battery mounted thereon), which impairs handling during operation of the router. In embodiments according to the present disclosure, good handling can be ensured regardless of the size of the battery.

According to one aspect of the present disclosure, a portable cutting machine for woodworking includes left and right support members, extending vertically (i.e. extending in an up-down direction in a state in which a base of the portable cutting machine is placed on a horizontal surface; hereinbelow all directions assume this state of the portable cutting machine), parallel to each other. That is, the left and right support members are spaced apart in a left-right direction that is perpendicular to the up-down direction of the portable cutting machine. A main body of the portable cutting machine is supported by the support members to be vertically movable relative to the support members (i.e. movable in the up-down direction) and is located at a position between the support members in the left-right direction. The main body is biased upwardly by the biasing force of a compression spring disposed inside at least one of the support members. A cutter bit is preferably mountable on an output shaft of the main body (e.g., a motor or rotor shaft of an electric motor disposed within the main body). The portable cutting machine further includes a battery mounting part in (on) which one battery (rechargeable battery pack or rechargeable battery cartridge) is removably mountable, and the battery mounting part is located above the main body in the up-down direction. The battery mounting part is configured to hold the one battery oriented so that the longitudinal direction of the battery is at an angle of 70 to 90 degrees with respect to an imaginary plane that contains the left and right support members (i.e. an imaginary plane that extends in the up-down direction and the left-right direction). Herein, the term “longitudinal direction of the battery” is intended to mean the dimension (from among length, width and height) of the battery that has the longest extension.

In such an embodiment of the present teachings, the battery mounted on the battery mounting part is held in a compact region in the left-right direction. The portable cutting machine can thereby be made more compact in the left-right direction. The inclination of the orientation at which the battery is held with respect to the imaginary plane includes inclinations in any direction, including the up-down and left-right directions.

According to another aspect of the present disclosure, a portable cutting machine for woodworking includes left and right support members, extending vertically (i.e. in the up-down direction as noted above), parallel to each other, and a main body, which is supported by the support members to be vertically movable (in the up-down direction) and is located at a position between the support members in the left-right direction. The main body is biased upwardly by the biasing force of a compression spring disposed inside at least one of the support members. A cutter bit is preferably mountable on an output shaft of the main body (e.g., a motor or rotor shaft of an electric motor that protrudes downward from the main body). The portable cutting machine further includes two grip parts (handles) respectively provided on the left and right sides of the main body and a battery mounting part, on which one battery is removably mounted. The battery mounting part is located above the main body in the up-down direction. The battery mounting part holds one battery oriented so that the longitudinal direction of the battery is angled (oblique) with respect (relative) to an imaginary plane that contains the left and right support members (i.e. an imaginary plane that extends in the up-down direction and the left-right direction).

In such an embodiment of the present teachings, the battery mounted on the battery mounting part is held in a compact region in the left-right direction. It is thereby less likely that the battery will get in the way of a user gripping the grip parts during a woodworking operation, and thus the handling of the portable cutting machine during woodworking can be improved. The inclination of the orientation at which the battery is held with respect to the imaginary plane includes inclinations in any direction, including the up-down and left-right directions.

### BRIEF DESCRIPTION OF THE DRAWINGS

FIG. 1 is an overall oblique view of a portable cutting machine for woodworking according to an exemplary embodiment in the state in which a battery is mounted on a battery mounting part of a main body of the portable cutting machine.

FIG. 2 is an overall oblique view of the portable cutting machine of FIG. 1 in the state in which the battery has been removed.

FIG. 3 is a view seen from arrow III in FIG. 1.

FIG. 4 is a longitudinal cross-sectional view of the portable cutting machine of FIGS. 1-3 in the state in which the main body is located at its top dead point (i.e. an upper movement limit relative to a base of the portable cutting machine).

FIG. 5 is another longitudinal cross-sectional view of the portable cutting machine of FIGS. 1-3 in the state in which the main body is located at its maximumly lowered end position (i.e. a lower movement limit relative to a base of the portable cutting machine).

FIG. 6 shows bottom views of two types of battery units for size comparison, wherein the upper view shows a bottom view of a small battery, and the lower view shows a bottom view of a large battery.

FIG. 7 is a front view of the portable cutting machine of FIGS. 1-3 in the state in which a small battery has been mounted and the main body is located at its top dead point.

FIG. 8 is a view seen from arrow VIII in FIG. 7.

FIG. 9 is a front view of the portable cutting machine of FIGS. 1-3 in the state in which a large battery has been mounted and the main body is located at its top dead point.

FIG. 10 is a view seen from arrow X in FIG. 9.

### DETAILED DESCRIPTION OF THE INVENTION

In one or more embodiments according to the present teachings, a (the) battery mounting part holds a (the one) battery oriented so that the longitudinal direction thereof is angled at 50 degrees or greater, with respect to the above-described imaginary plane. Accordingly, compared to an orientation in which the longitudinal direction thereof is aligned with (parallel to) the imaginary plane, the battery is held in more compactly in the left-right direction.

In one or more embodiments according to the present teachings, the battery mounting part holds a (the one) battery oriented so that the longitudinal direction thereof is angled at 70 degrees or greater, with respect (relative) to the imaginary plane. Accordingly, the battery is held in even more compactly, in the left-right direction, than the case of an orientation in which the longitudinal direction thereof is aligned with (parallel to) the imaginary plane.

In one or more embodiments according to the present teachings, the battery mounting part holds the (one) battery oriented so that the longitudinal direction thereof is angled at approximately 90 degrees, with respect (relative) to the imaginary plane. Accordingly, the battery is held most compactly in the left-right direction. Herein, “approximately” is intended to mean, e.g., within a range of 85-95 degrees, more preferably in a range of 88-92 degrees.

In one or more embodiments according to the present teachings, the battery mounting part has a receiving opening on the user side (i.e. the side of the portable cutting machine designed to be closest to the user during operation thereof), which receives (holds) the battery, and a stopper that blocks (limits further) movement of a battery that has been moved through the receiving opening in the direction away from the user. Accordingly, the battery is mounted in the battery mounting part by being moved in the direction away from the user and is removed from the battery mounting part by being moved in the direction approaching (towards) the user. Good detachability of the battery is thereby ensured.

In one or more embodiments according to the present teachings in which the portable cutting machine is designed to be used with multiple types of batteries of different sizes and/or weights that are interchangeably mountable on the battery mounting part, the position, in the left-right direction, of the center of gravity of the portable cutting machine for woodworking preferably remains constant regardless of which type of battery is mounted on the battery mounting part. Accordingly, when multiple types of batteries are interchangeably mountable on the battery mounting part, stable handling is ensured when maneuvering the portable cutting machine for woodworking.

In one or more embodiments according to the present teachings in which the portable cutting machine is designed to be used with multiple types of batteries of different weights that are interchangeably mountable on the battery mounting part, the battery mounting part is configured to hold the battery so that the position of the center of gravity of the portable cutting machine shifts toward the user when a heavier battery is mounted on the battery mounting part (as compared to a lighter battery). Accordingly, since, in ordinary cutting work, the portable cutting machine for woodworking is pushed in the direction away from the user to advance the cutting work, when a heavy battery is mounted, the portable cutting machine for woodworking is unlikely to fall over toward the user.

In one or more embodiments according to the present teachings, when the battery is mounted on the battery mounting part, the position of the center of gravity of the main body that includes the battery in the front-rear direction (which is perpendicular to the up-down and left-right directions) is preferably located on (in) the above-described imaginary plane. Accordingly, manual raising and lowering of the main body relative to the support members can be smoothly performed.

In one or more embodiments according to the present teachings, the main body comprises: an electric motor that rotates a (the) cutter bit; and a controller that houses a control board (circuit board) including a controller (e.g., one or more microprocessors, memory/storage, power FETS, etc.) that controls the operation (driving, energization) of the electric motor. The controller is disposed above the electric motor, and is oriented so that the rotational axis of a motor or rotor shaft of the electric motor intersects the control board. Accordingly, the controller is disposed in a compact manner in the up-down direction.

In one or more embodiments according to the present teachings, the portable cutting machine further comprises a manipulation member (e.g., a dial) of a top dead point adjustment mechanism that is located at the upper part of one of the support members. The top dead point adjustment mechanism is designed to set (restrict) the range of upward movement of the main body relative to the support members (and to a base that contacts the workpiece during a woodworking operation). When the main body is located at the maximumly lowered end position of the downward movement range thereof (i.e. relative to the support members and the base), the battery mounted on the battery mounting part is located, in the up-down direction, in a region overlapping with the manipulation member in the left-right direction. Accordingly, the main body can be lowered to a height (depth) at which the battery is located at the (lateral) side of the manipulation member. A deeper cutting depth of the cutter bit in the workpiece can thereby be achieved, without resulting in (requiring) a larger portable cutting machine for woodworking.

In one or more embodiments according to the present teachings, the main body has an air inlet, on the side opposite, in the left-right direction, to the manipulation member, for drawing in external air to cool the electric motor. Accordingly, external air can be smoothly drawn into the air inlet without being subjected to resistance from the manipulation member. The cooling efficiency of the electric motor is thereby enhanced.

In one or more embodiments according to the present teachings, the battery mounting part includes a housing having a structure split into left and right halves, which are butt-joined to each other. Accordingly, the work of assembling the battery mounting part can be facilitated.

In one or more embodiments according to the present teachings, the portable cutting machine for woodworking has a (the) base that is configured to contact the workpiece during a woodworking operation. The main body is inseparable from the base. Accordingly, each of the aforementioned features can be applied to a plunge type (plunge-base) portable cutting machine for woodworking in which the main body is vertically movable along (relative to) the left and right support members. The portable cutting machine for woodworking is a dedicated plunge type cutting machine in which the main body cannot be separated from the base and replaced with a base for a fixed type that does not have support members for vertical relative movement.

### Exemplary Embodiment

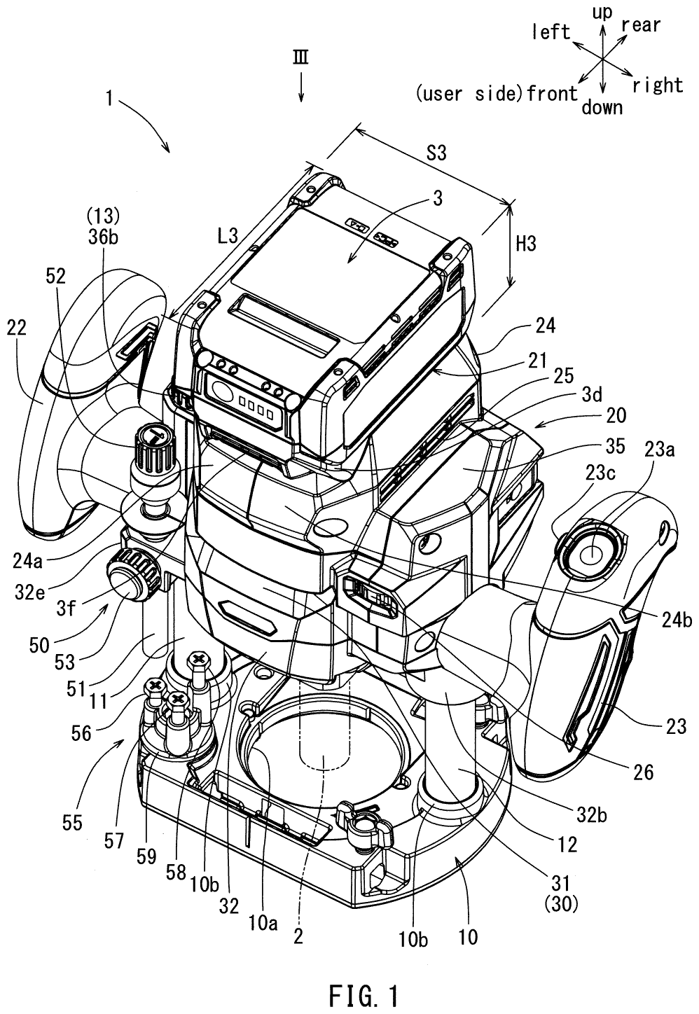

As shown in FIGS. 1 to 3, in the exemplary embodiment of the present disclosure, as one example of a portable cutting machine 1 for woodworking, a so-called plunge type router (plunge base router or simply plunge router) is illustrated. The portable cutting machine 1 for woodworking has a base 10 that is brought into contact with a workpiece W during a woodworking operation and a main body 20 that is vertically movably supported on the base 10. The main body 20 can be moved downward, such that a cutter bit 2 cuts into the workpiece W. By moving the portable cutting machine 1 for woodworking along the direction of the surface of workpiece W in a state in which the main body 20 has been moved downward, the cutter bit 2 cuts along the direction of the surface of the workpiece W.

The base 10 has an annular shape with a circular work aperture 10a in the center. The cutter bit 2 cuts into the workpiece W on the inner circumferential side of the work aperture 10a. Left and right support members (columns) 11, 12 are supported on (attached to) the top surface of the base 10. The left and right support members 11, 12 are each sleeve shaped, i.e. hollow circular cylinders. The left and right support members 11, 12 are respectively affixed to the base 10 on the left and right of the work aperture 10a. The left and right support members 11, 12 extend upward parallel to each other from the top surface of the base 10. The main body 20 is supported by the left and right support members 11, 12 to be vertically movable relative to the base 10.

The main body 20 has a battery mounting part 21 located at an upper part, on which one battery 3 is mountable. Grip parts (handles) 22, 23 are respectively provided on the left and right sides of the main body 20. The user of this portable cutting machine 1, who is located to (at) the front of the main body 20 (according to the directions shown in the Figures), grips the left-side grip part 22 with the left hand and grips the right-side grip part 23 with the right hand, so as to maneuver the portable cutting machine 1 to perform the woodworking operation. Then, the user maneuvers the portable cutting machine 1 frontward and rearward and to the left and right, whereby the cutter bit 2 cuts into the workpiece W and cutting work is performed.

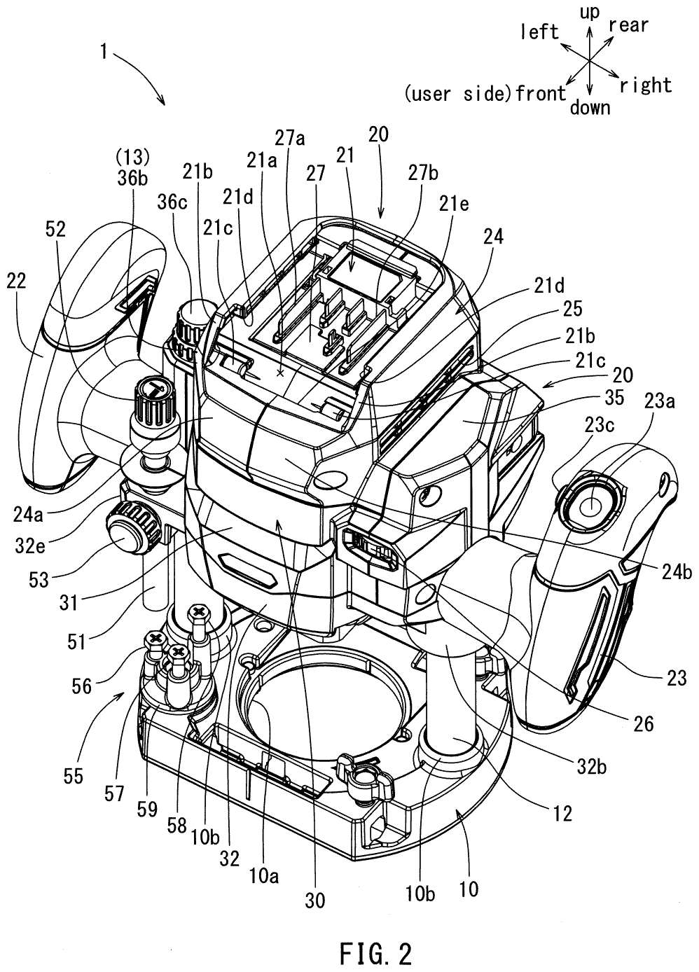

As shown in FIG. 2, the battery mounting part 21 has a mount housing 24. The mount housing 24 has a structure split into left and right halves, in which a left mount housing 24a and a right mount housing 24b are butt-joined to each other. A receiving opening 21a, by way of which the battery 3 is received (inserted, mounted), is provided in (at) the front of the mount housing 24. At the two left and the right ends of the receiving opening 21a, stoppers 21b are provided, which block (limit further) movement of the battery 3 towards the rear (the direction away from the user). Elastic bodies 21c (elastomeric bodies, such as rubber pins) are respectively provided on the inside of each of the left and right stoppers 21b to curtail rattling of the mounted battery 3 during a woodworking operation.

A pair of left and right rails (slide rails) 21d are provided on the mount housing 24. The left and right rails 21d extend parallel to each other, rearward, from the left and right sides of the receiving opening 21a. A terminal board (terminal block) 27, to which the battery 3 is electrically connected, is provided between the left and right rails 21d. A positive electrode connection terminal 27a and a negative electrode connection terminal 27b are provided on the terminal board 27. The terminal board 27 is sandwiched between the left mount housing 24a and the right mount housing 24b so as to be assembled with the battery mounting part 21.

As shown in FIG. 1, the battery 3 has a generally hexahedral (cuboid) shape with a length L3, a width S3, and a height H3. The battery 3 can be mounted on the battery mounting part 21 oriented so that the length L3 direction (longitudinal direction L3) coincides with the front-rear direction. That is, the length L3 direction is the longest dimension of the battery 3 from among the length, width and height (depth) directions of the battery 3. With the front end of the battery 3 oriented to be directed toward the user (frontward), the battery 3 is mounted on the battery mounting part 21 by being moved rearward (the direction away from the user) though the receiving opening 21a. The battery 3 is removed from the battery mounting part 21 by being moved frontward (in the direction approaching the user).

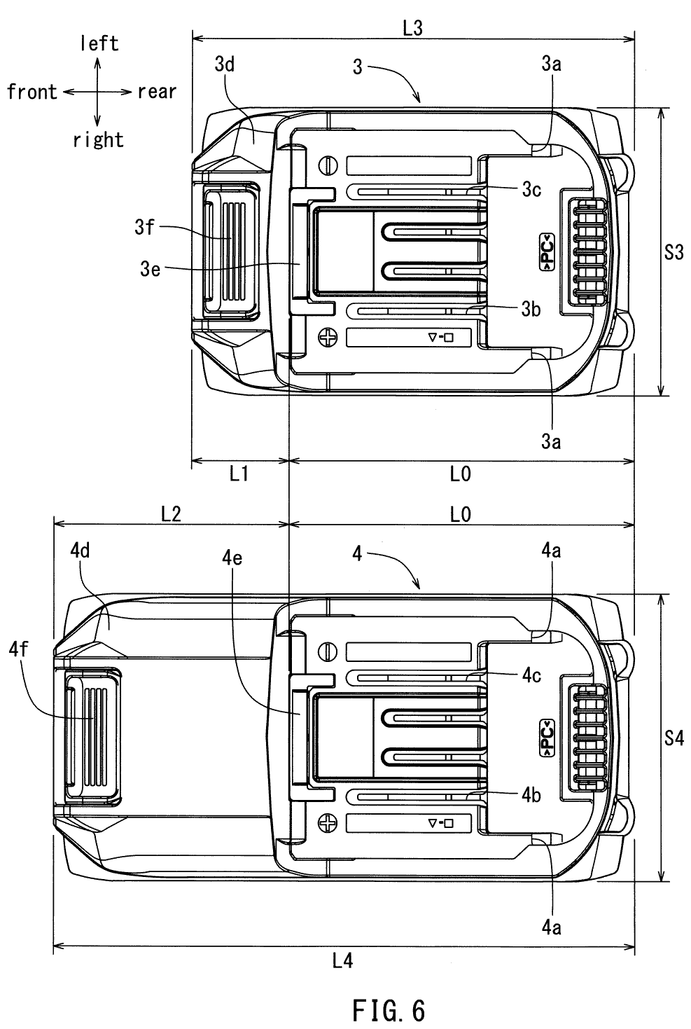

As shown in FIG. 6, a pair of left and right rail receiving parts (grooves, slots) 3a are provided on the bottom surface of the battery 3. Here, it is noted that all directional references to the battery 3 hereinbelow are to be understood as being with reference to the battery 3 in the mounted state on the battery mounting part 21 according to the directions shown in the Figures. By engaging the rails 21d in the left and right rail receiving parts 3a, the battery 3 is supported to be slidable in the front-rear direction (removal direction, mounting direction) with respect to the battery mounting part 21.

A positive electrode terminal receiving part 3b and a negative electrode terminal receiving part 3c are provided between the left and right rail receiving parts 3a. Upon mounting the battery 3 on the battery mounting part 21, the positive electrode connection terminal 27a is connected to the positive electrode terminal receiving part 3b, and the negative electrode connection terminal 27b is connected to the negative electrode terminal receiving part 3c. The battery 3 is thereby electrically connected to the battery mounting part 21.

A step 3d that protrudes downward in a V-shape is provided at the front end of the battery 3. A locking hook 3e is provided rearward of the step 3d. The locking hook 3e is spring biased in a downward protruding direction (locking direction). An unlocking button 3f is provided at the front of the step 3d. The unlocking button 3f is mechanically coupled to the locking hook 3e. Therefore, when the user manipulates (presses) the unlocking button 3f by pushing upward with a finger, the locking hook 3e retracts upward against the bias of the spring so that the battery 3 can be removed from the battery mounting part 21.

A locking recess 21e is provided between the stoppers 21b of the battery mounting part 21. Upon mounting the battery 3 on the battery mounting part 21 by moving the battery 3 rearward relative to the battery mounting part 21, the rear portions of the two left and right ends of the step 3d respectively come into contact the stoppers 21b at two locations on the left and right. Further rearward (mounting direction) movement of the battery 3 is thereby blocked. In addition, upon mounting the battery 3 on the battery mounting part 21, the locking hook 3e fits into the locking recess 21e. Frontward (removal direction) movement of the battery 3 is thereby blocked as long as the locking hook 3e is disposed in the locking recess 21e.

Elastic bodies 21c are disposed on the two left and right sides of the locking recess 21e. Upon mounting the battery 3 on the battery mounting part 21, the elastic bodies 21c are brought into contact with the step 3d. Rattling of the battery 3 during a woodworking operation is thereby curtailed.

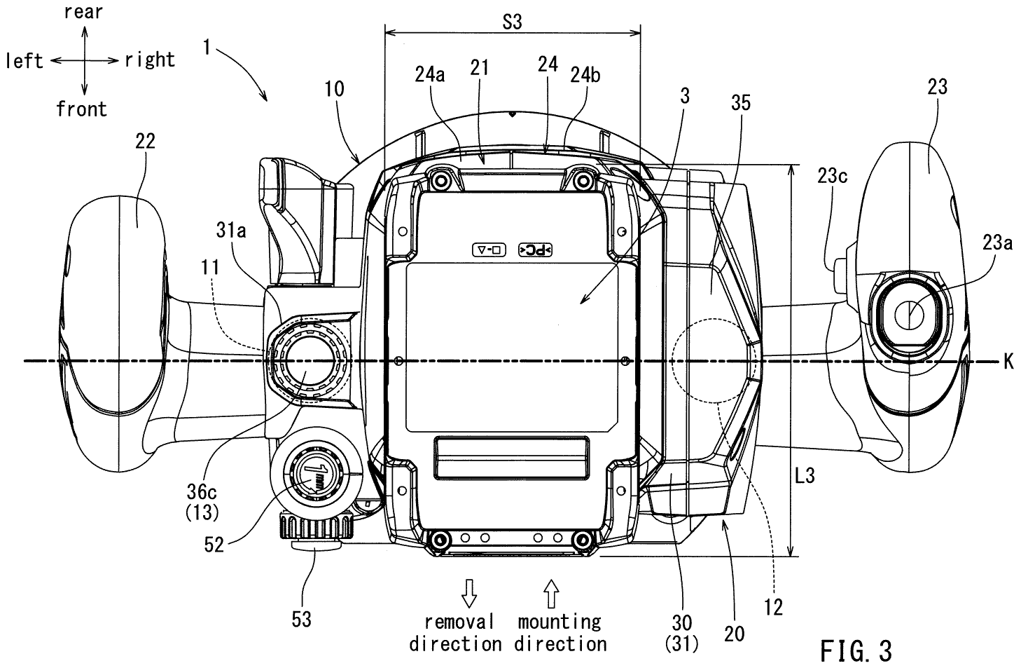

As shown in FIGS. 3, 7, and 8, the battery 3 is held in (on) the battery mounting part 21 orientated such that the longitudinal direction L3 is at an angle of 90 degrees, in a plan view, and approximately 90 degrees, in a side view, with respect to an imaginary plane K that contains the left and right support members 11, 12 (orthogonal orientation). The imaginary plane K thus extends in the up-down and left-right directions of the portable cutting machine 1. The battery 3 is thereby held in a region that does not protrude between the left and right support members 11, 12, and which is the most compact orientation of the battery 3 in the left-right direction.

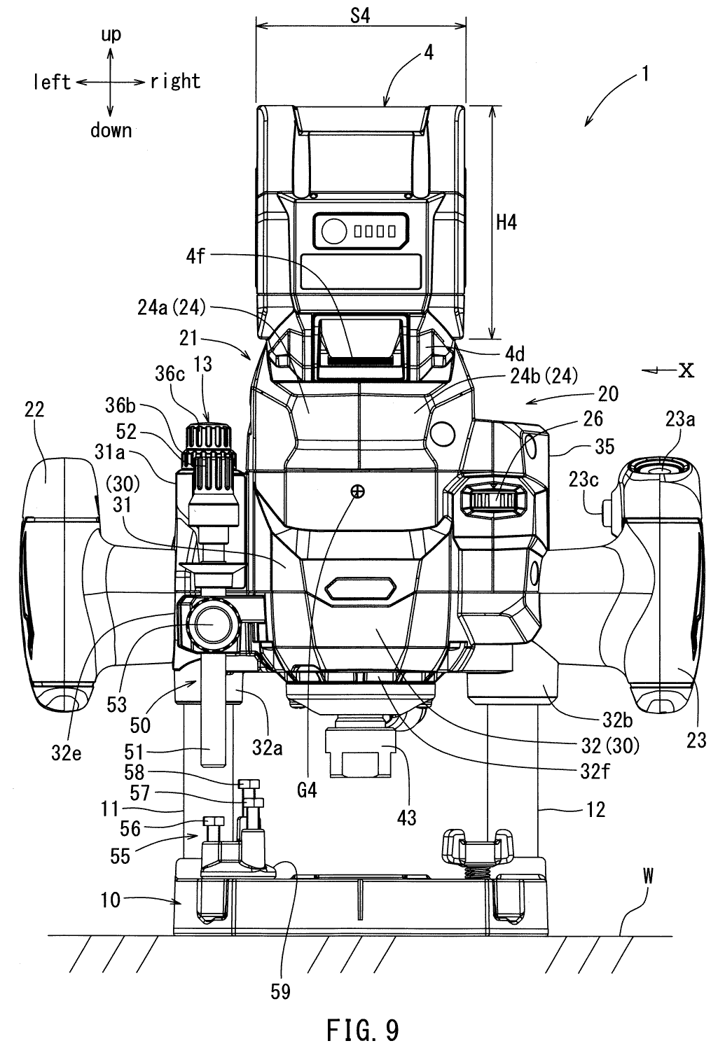

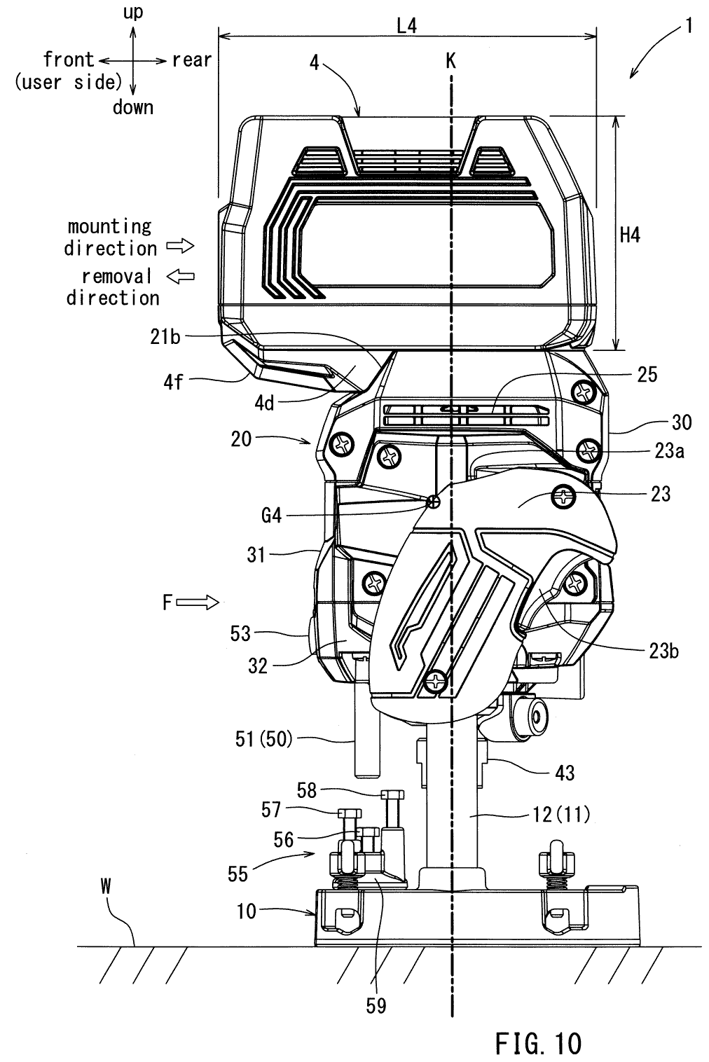

The battery mounting part 21 is configured (adapted) such that a large battery 4 having a relatively large capacity (large battery 4) can be mounted on the battery mounting part 21 instead of the small battery 3 having a relatively small capacity (small battery 3). The large battery 4 houses more battery cells than the small battery 3, and thus has a greater size. Therefore, the large battery 4 is also heavier than the small battery 3. FIGS. 1, 3, 4, 5, 7, 8 show the state in which the small battery 3 is mounted. FIGS. 9, 10 show the state in which the large battery 4 is mounted.

As shown in FIG. 6, the length L4 of the large battery 4 is greater than the length L3 of the small battery 3 (L3<L4). The height H4 of the large battery 4 is greater than the height H3 of the small battery 3 (H3<H4). The width S3 of the small battery 3 and the width S4 of the large battery 4 are the same.

The small battery 3 and the large battery 4 are interchangeably mountable on the (common) battery mounting part 21. Therefore, the positional relationships between the left and right rail receiving parts 3a, the positive electrode terminal receiving part 3b, and the negative electrode terminal receiving part 3c, with respect to the locking hook 3e of the small battery 3 shown in the upper panel of FIG. 6 are the same as the positional relationships between the left and right rail receiving parts 4a, the positive electrode terminal receiving part 4b, and the negative electrode terminal receiving part 4c, with respect to the locking hooks 4e of the large battery 4 shown in the lower panel of FIG. 6.

Upon mounting the large battery 4 on the battery mounting part 21, the positive electrode connection terminal 27a is connected to the positive electrode terminal receiving part 4b, and the negative electrode connection terminal 27b is connected to the negative electrode terminal receiving part 4c. The large battery 4 is thereby electrically connected to the battery mounting part 21.

A step 4d that protrudes downward in a V shape is provided on (at) the front side of the large battery 4. The front end of the battery 4 is located at a position that farther forward than the front end of the small battery 3 with respect (relative) to the locking hook 4e; i.e. the distance between the front end and the locking hook 4e of the large battery 4 is greater than the distance between the front end and the locking hook 3e of the small battery 3, as can be seen in FIGS. 6, 8 and 10. The locking hook 4e is spring biased in a downward protruding direction (locking direction). An unlocking button 4f is provided at the front of the step 4d. The unlocking button 4f is mechanically coupled to the locking hook 4e. Therefore, when the user manipulates (presses) the unlocking button 4f by pushing upward with a finger, the locking hook 4e retracts upward against the bias of the spring.

As was noted above, the locking recess 21e is provided between the left and right stoppers 21b of the battery mounting part 21. Upon mounting the large battery 4 on the battery mounting part 21 by moving the large battery 4 rearward relative to the battery mounting part 21, the rear portions of the left and right ends of the step 4d respectively come into contact with the left and right stoppers 21b, as can be seen in FIG. 10. Further rearward (mounting direction) movement of the large battery 4 is thereby blocked. In addition, upon mounting the large battery 4 on the battery mounting part 21, the locking hook 4e fits into the locking recess 21e. Frontward (removal direction) movement of the large battery 4 is thereby blocked as long as the locking hook 4e remains in the locking recess 21e. Upon mounting the large battery 4 on the battery mounting part 21, the elastic bodies 21c are brought into contact with the step 4d. Rattling of the large battery 4 in the mounted state is thereby curtailed during a woodworking operation.

As shown in FIG. 6, the length L0 from the rear end of the small battery 3 to the locking hook 3e and the length L0 from the rear end of the large battery 4 to the locking hook 4e are the same. The length L2 from the front end of the large battery 4 to the locking hook 4e is greater than the length L1 from the front end of the small battery 3 to the locking hook 3e. Therefore, the length from the locking hook 4e to the front end of the large battery 4 is greater than that in the small battery 3 by (L2−L1). This difference in length (L2−L1) corresponds to the difference between the length L4 of the large battery 4 and the length L3 of the small battery 3 (L4−L3).

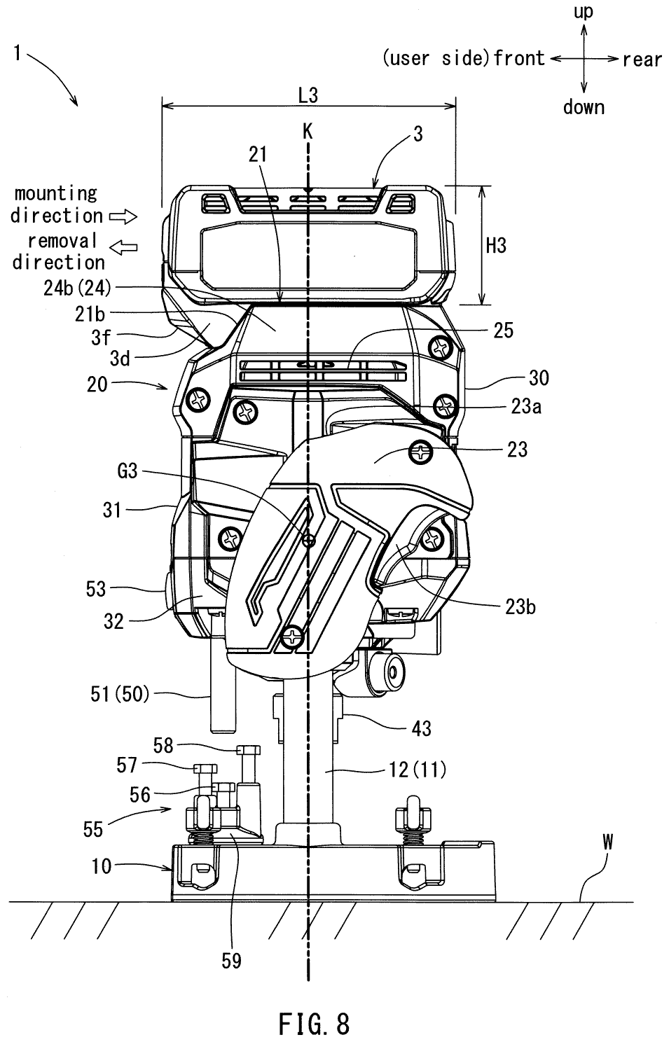

The step 4d of the large battery 4 is longer in the length direction than the step 3d of the small battery 3 by the length difference (L2−L1). Therefore, as shown in FIG. 10, when the large battery 4 is mounted on the battery mounting part 21, the large battery 4 is held in an orientation such as to protrude toward the user by the length difference (L2−L1). Therefore, as can be seen by comparing FIGS. 8 (small battery 3) and 10 (large battery 4), the position in the front-rear direction of the center of gravity G4 of the main body 20, which has the large battery 4 mounted thereon (FIG. 10), shifts frontward (toward the user) by, for example, approximately 7 millimeters, relative to the position in the front-rear direction of the center of gravity G3 of the main body 20, which has the small battery 3 mounted thereon (FIG. 8).

During cutting work, the user maneuvers the tool by applying a rearward pushing force F to the main body 20. Therefore, because the position of the center of gravity G4 shifts toward the user (frontward) when a large battery 4 is mounted on the battery mounting part 21 (FIG. 10), as compared to when a small battery 3 is mounted thereon (FIG. 8), it is unlikely that the portable cutting machine 1 will fall over rearward (in the direction of pushing) during the maneuvering to perform the woodworking operation.

Thus, both when the small battery 3 is mounted and when the large battery 4 is mounted, the positions in the front-rear direction of the centers of gravity G3, G4 are located within the range of the diameter (i.e. thickness or width in the front-rear direction) of the support members 11, 12 as can be seen in FIGS. 8 and 10. Therefore, manual raising and lowering of the main body 20 relative to the base 10 can be smoothly performed both when the small battery 3 is mounted and when the large battery 4 is mounted.

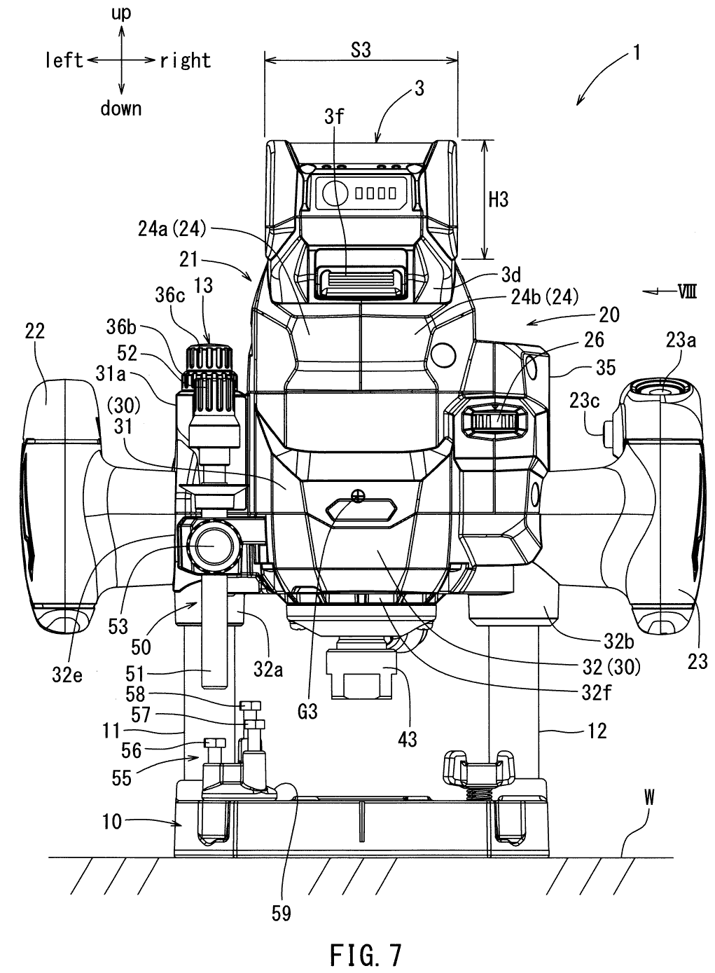

The width S3 of the small battery 3 and the width S4 of the large battery 4 are the same (S3=S4). Therefore, the position, in the left-right direction, of the center of gravity G3 of the main body 20 on which the small battery 3 is mounted, as shown in FIG. 7, is the same or at least substantially the same as the position, in the left-right direction, of the center of gravity G4 of the main body 20 on which the large battery 4 is mounted, as shown in FIG. 9. Therefore, the center of gravity G3 and the center of gravity G4 are both located substantially in the center of the main body 20 in the left-right direction. Since the position, in the left-right direction, of the center of gravity G3 or G4 of the main body 20 does not (significantly) change when different-sized batteries (3, 4) are interchangeably mounted, the left-right weight balance of the main body 20 is preserved (maintained) regardless of which battery has been mounted on the portable cutting machine 1. Good handling in raising and lowering of the main body 20 is thereby ensured. In addition, since the position of the center of gravity G3 or G4 in the left-right direction does not change (or at least does not significantly change), the handling during maneuvering while performing cutting work does not change greatly depending on the battery that is mounted, and good handling is ensured in this regard.

The height H4 of the large battery 4 is greater than the height H3 of the small battery 3 (H3<H4). Therefore, the height direction position of the center of gravity G4 of the main body 20 on which the large battery 4 is mounted, as shown in FIG. 9, is, for example, approximately 35 millimeters higher than the height direction position of the center of gravity G3 of the main body 20 on which the small battery 3 is mounted, as shown in FIG. 7.

Further features and structures of the portable cutting machine 1 will now be described with reference to FIGS. 1-5. The main body 20 includes a main body housing 30. The main body housing 30 has an upper housing 31 made from a polymer (plastic, synthetic resin) and a lower housing 32 made from metal. The lower housing 32 is joined to the lower side of the upper housing 31. The mount housing 24 of the battery mounting part 21 is joined at the upper part of the upper housing 31. The mount housing 24 is joined to the upper part of the upper housing 31 by sandwiching the upper part of the upper housing 31 from left and right between the left mount housing 24a and the right mount housing 24b. The work of assembling the battery mounting part 21 onto the main body housing 30 can be facilitated owing to the fact that the mount housing 24 has a structure split into left and right halves.

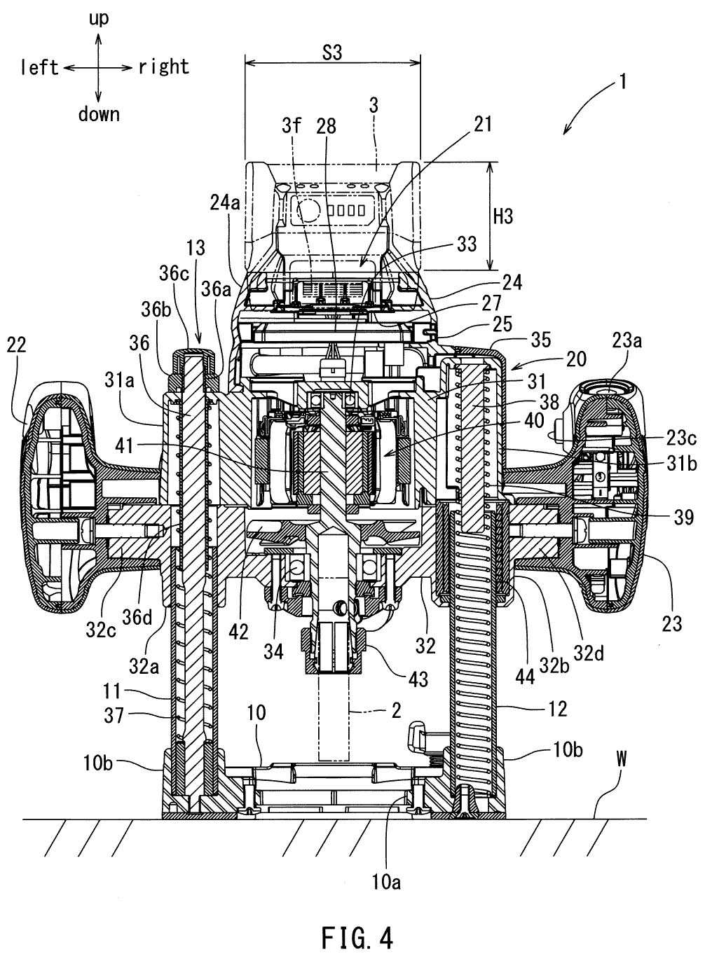

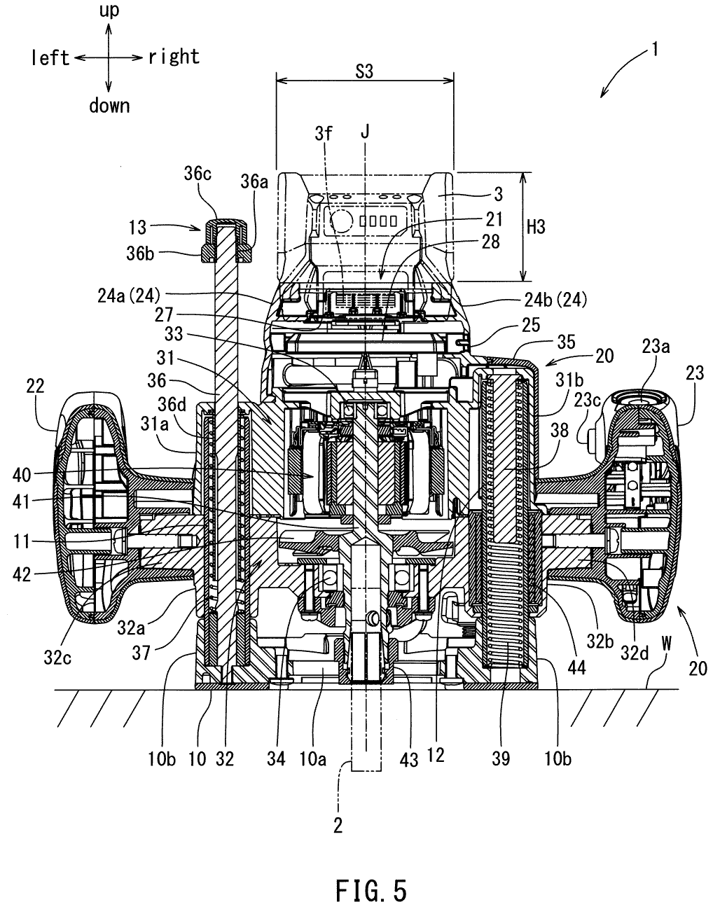

As shown in FIGS. 4 and 5, an electric motor 40 is housed in the upper housing 31. A motor (rotor) shaft 41 of the electric motor 40 is rotatably supported by a bearing 33 provided in the upper housing 31 and a bearing 34 provided in the lower housing 32. A cooling fan 42 is mounted on the motor shaft 41 below the electric motor 40. The motor shaft 41 rotates around a motor (rotational) axis J that extends in the up-down direction.

An air inlet 25 is provided on the right side of the mount housing 24 of the battery mounting part 21. When the electric motor 40 is driven (energized) thereby rotating the cooling fan 42, external air is drawn into the mount housing 24 and the main body housing 30 via the air inlet 25. The external air then flows downwards and cools the electric motor 40. The cooling fan 42 is accommodated in the lower housing 32. After cooling the electric motor 40, the (heated) external air is discharged from (through, via) exhaust ports 32f (see FIGS. 7 and 9) provided on (in) the bottom surface of the lower housing 32.

A generally flat rectangular controller 28 is housed in the mount housing 24. The controller 28 has a control board (circuit board) that supports a control circuit, which is primarily for controlling the operation of the electric motor 40. The controller 28 is also cooled by the external air introduced into the mount housing 24 via the air inlet 25. The controller 28 is disposed above the electric motor 40. The plane of the controller 28 (i.e. the control board) is oriented so that the surface direction thereof is substantially orthogonal to the motor axis J; i.e. the motor axis J intersects the controller 28. The controller 28 is thereby accommodated in a compact manner in the up-down direction.

The lower part of the motor shaft 41 projects downward from (beyond, outside of) the lower housing 32. A chuck 43 is provided at the lower part of the motor shaft 41. A rod-shaped cutter bit 2 is coaxially mounted on the lower part of the motor shaft 41 using the chuck 43.

Vertically elongated support cylinders 31a, 31b are respectively provided on the left and right sides of the upper housing 31. Vertically elongated support cylinders 32a, 32b are respectively provided on the left and right sides of the lower housing 32. The left-side support cylinder 31a and the left-side support cylinder 32a are disposed coaxially with each other. The right-side support cylinder 31b and the right-side support cylinder 32b are disposed coaxially with each other. The right-side support cylinder 31b and the right-side support cylinder 32b are covered by an auxiliary housing 35.

The lower parts of the left and right support members 11, 12 are respectively non-detachably inserted into (non-detachably affixed to) joining cylinders 10b provided on the top surface of the base 10. As shown in FIG. 4, in the state in which the main body 20 is located at the top dead point (upper limit position), the upper parts of the left and right support members 11, 12 respectively protrude (extend) into only the lower support cylinders 32a, 32b. When the main body 20 is moved downward, the left and right support members 11, 12 respectively also protrude (extend) into the upper support cylinders 31a, 31b.

As shown in FIG. 5, the main body 20 is supported so as to be movable downward, as far as a maximumly lowered end position (lower limit position) at which the lower parts of the lower support cylinders 32a, 32b contact the joining cylinders 10b on the base 10. In the state in which the main body 20 is located at the maximumly lowered end position, the upper parts of the left and right support members 11, 12 are in the vicinity of the upper parts of the upper support cylinders 31a, 31b, respectively. In the normal use state, the main body 20 is moved (positioned) vertically, above the maximumly lowered end position, by a bottom dead point stopper 50, which is described below. The bottom dead point of the main body 20 is defined by the bottom dead point stopper 50.

Referring now to the left-side support member 11, a top dead point adjustment mechanism 13 for adjusting the position of the top dead point of the main body 20 is provided at the upper part of the left-side support member 11. The top dead point adjustment mechanism 13 includes a vertically elongated rod-shaped auxiliary member (rod, shaft) 36. One auxiliary member 36 is disposed in (extends through) the interiors (on the inner circumferential sides) of the upper and lower support cylinders 31a, 32a. The lower end part of the auxiliary member 36 is joined (affixed) to the base 10. The upper part of the auxiliary member 36 protrudes upward from the support cylinder 31a. A male thread 36a is provided on the upward end of the auxiliary member 36. A lock nut 36b, serving as a manipulation member, is screwed onto the male thread 36a. The male thread 36a is made from steel and the lock nut 36b is made from a synthetic resin (plastic, polymer).

The position of the top dead point of the main body 20 is determined (set) by the top surface of the left-side support cylinder 31a contacting the lock nut 36b; i.e. when the top surface of the left-side support cylinder 31a contacts the lock nut 36b, the main body 20 is at its top dead point. The position of the top dead point of the main body 20 can be vertically adjusted by changing the screw position of the lock nut 36b relative to the male thread 36. A cap 36c is provided above the lock nut 36b. The cap 36c is integrated with the auxiliary member 36 by press fitting, so as not to come off, even if the lock nut 36b has been loosened and moved upward. The base of the female thread in the lock nut 36b is shallower than a normal thread. Therefore, when the lock nut 36b is screwed into the male thread 36a, the leading edge of the male thread 36a bites into this shallow portion of the female thread, so that the lock nut 36b is elastically retained. This elastic retention effect prevents the lock nut 36b from loosening.

An auxiliary sleeve 36d is joined (affixed) to the upper part of the support cylinder 31a. The auxiliary sleeve 36d extends downward. The auxiliary sleeve 36d extends in a range starting from the upper support cylinder 31a and reaching the lower support cylinder 32a. The auxiliary member 36 is inserted in (extends through) the interior (on the inner circumferential side) of the auxiliary sleeve 36d so as to be vertically displaceable, in relative terms.

One compression spring 37 is disposed on the outer circumferential side of the auxiliary member 36 and the auxiliary sleeve 36d. The lower part of the compression spring 37 passes along the inner circumferential side (surface) of the support member 11 and is brought into contact with the top surface of the base 10 (the top surface of the joining cylinder 10b). The upper part of the compression spring 37 contacts the upper part of the support cylinder 31a.

Referring now to the right-side support member 12, one cylindrical linear ball bearing 44 is mounted in the interior (on the inner circumferential side) of the right-side lower support cylinder 32b. The right-side support member 12 is inserted into (through) the interior (the inner circumferential side) of the linear ball bearing 44. The right-side support member 12 is supported by the linear ball bearing 44 so as to be vertically movable with respect (relative) to the main body housing 30.

An auxiliary member 38 is joined to the right-side upper part of the upper support cylinder 31b. The auxiliary member 38 extends downward from the upper part of the support cylinder 31b. The lower end of the auxiliary member 38 penetrates into the interior (inner circumferential side) of the support member 12. One compression spring 39 is disposed along the inner circumferential side of the support member 12 and the outer circumferential side of the auxiliary member 38. The lower part of the compression spring 39 contacts the top surface of the base 10 (the bottom surface of the joining cylinder 10b). The upper part of the compression spring 39 contacts the top surface of the support cylinder 31b.

The main body 20 is biased in the upward movement direction by the left and right compression springs 37, 39. The main body 20 is manipulated (pressable) downward against the biasing force of the compression springs 37, 39.

A left-side mount 32c is integrally provided on the left-side lower support cylinder 32a. The left-side mount 32c is provided so as to protrude to the left. The left-side mount 32c protrudes to the left beyond the left side of the upper housing 31. A left-side grip part (handle) 22 is attached on the left side of the main body 20 via the left-side mount 32c. The left-side grip part 22 has a grip shape that is easy for the user to grip with the left hand.

A right-side mount 32d is integrally provided on the right-side lower support cylinder 32b. The right-side mount 32d is provided so as to protrude to the right. The right-side mount 32d protrudes to the right beyond the right side of the auxiliary housing 35. A right-side grip part (handle) 23 is attached to the right side of the main body 20 via the right-side mount 32d. The right-side grip part 23 has a grip shape that is easy for the user to grip with the right hand.

A standby switch 23a is provided on the upper part of the right-side grip part 23. When the standby switch 23a is manually pressed, power is supplied from the battery 3 (start-standby state) to the controller 28. When the standby switch 23a is manually pressed in the start-standby state, it switches to a state in which the power is shut off. As shown in FIG. 8, a trigger type start switch 23b is provided on the rear surface of the right-side grip part 23. When the start switch 23b is manually pulled in the start-standby state, the electric motor 40 starts (is energized, driven), whereby the cutter bit 2 is rotated. When the start switch 23b is no longer manually pulled (i.e. the user releases the start switch 23b), the electric motor 40 stops, resulting in the start-standby state.

A lock-on button 23c, which holds the start switch 23b in the pulled state, is disposed on the left side of the right-side grip part 23. When the lock-on button 23c is manually pressed in a state in which the start switch 23b is being pulled by the user, the pulled state of the start switch 23b is locked. Continuous cutting work such as cutting long grooves can thereby be facilitated. When the start switch 23b is manually pulled strongly in the locked-on state, the locked-on state is released. The pulled state of the start switch 23b can thereby be released.

A speed change (adjustment) dial 26 is provided on the right side of the front surface of the main body 20. When the speed change (adjustment) dial 26 is manually rotated, the speed of the electric motor 40 is changed. The rotational speed of the cutter bit 2 can thereby be adjusted.

Referring again to FIG. 1, a stopper mount 32e is provided on the left side of the lower housing 32. The bottom dead point stopper 50, which determines the position of the bottom dead point (i.e. the variable lower limit) of the main body 20, is provided in the stopper mount 32e. The bottom dead point stopper 50 has a stopper screw (bolt) 51. A knob 52, which is gripped to manually rotate it, is provided at the upper part of the stopper screw 51. The stopper screw 51 passes vertically through the stopper mount 32e.

A half nut (not visible in the figures) is embedded in the stopper mount 32e. The half nut has a female thread, extending over approximately half of the circumference of the inner circumference, at the rear side of the hole, which can mesh with the stopper screw 51. The half nut is embedded in a manner allowing for the position to be changed in the radial direction of the stopper screw 51 (front-rear direction). The half nut is spring biased frontward (in the direction of meshing with the stopper screw 51). Meshing of the half nut with the stopper screw 51 is released by a rearward manual pressing of a release button 53, which is provided at the front surface of the stopper mount 32e. The position of the stopper screw 51 in the up-down direction can thereby be changed quickly.

When the manual pressing of the release button 53 is released, the half nut is meshed with the stopper screw 51. When the knob 52 is gripped in this meshed state and the stopper screw 51 is manually rotated, the upward position of the stopper screw 51 can be finely adjusted.

A stopper receiving part 55 is provided on the top surface of the base 10 below the stopper screw 51. The stopper receiving part 55 has three contact parts 56, 57, 58 at different heights. The three contact parts 56, 57, 58 are supported on the top surface of a circular mount 59. The three contact parts 56, 57, 58 are disposed at three equidistant positions around the periphery of the mount 59. The heights of the three contact parts 56, 57, 58 can each be independently finely adjusted.

By rotating the mount 59, any one of the three contact parts 56, 57, 58 can be positioned below the stopper screw 51. The position of the bottom dead point of the main body 20 is determined by the stopper screw 51 being brought into contact with the contact part 56 (or 57, 58). The bottom dead point of the main body 20 is adjusted as appropriate depending on the size of the cutter bit 2 and the desired cutting depth.

In the exemplary embodiment described above, the battery mounting part 21 holds the battery 3, 4 oriented so that the length direction L3, L4 is perpendicular to the (vertically extending) imaginary plane K that contains the left and right support members 11, 12. Accordingly, the battery 3, 4 that has been mounted on the battery mounting part 21 is held in a compact region in the left-right direction. The portable cutting machine 1 for woodworking can thereby be made more compact.

In the exemplary embodiment, the battery 3, 4 that has been mounted on the battery mounting part 21 is held in a compact region in the left-right direction, such that the battery 3, 4 is unlikely to get in the way of a user who is gripping the grip parts 22, 23. The handling of the portable cutting machine 1 for woodworking is thereby further enhanced.

In the exemplary embodiment, the battery mounting part 21 has a receiving opening 21a on the user side, which receives the battery 3, 4, and stoppers 21b that block (limit, restrict) movement of the battery 3, 4 that has been moved through the receiving opening 21a in the direction away from the user (rearward). Accordingly, the battery 3, 4 is mounted in (on) the battery mounting part 21 by being moved rearward in the direction away from the user, and is removed from the battery mounting part 21 by being moved frontward in the direction approaching (towards) the user. Good detachability of the batteries 3, 4 is thereby ensured.

In the exemplary embodiment, the battery mounting part 21 is configured to interchangeably mount at least two types of batteries 3 and 4 having different sizes and/or weights, and the center of gravity G3 and G4 of the main body 20 of the portable cutting machine 1 for woodworking does not change greatly (if at all) in the left-right direction, but rather is maintained at an approximately constant position in the left-right direction, regardless of which battery 3, 4 has been mounted. Accordingly, in embodiments in which the two types of batteries 3 and 4 are interchangeably mountable, stable handling is always ensured when maneuvering the portable cutting machine 1 for woodworking.

Similarly, in the exemplary embodiment, the battery mounting part 21 is configured to interchangeably mount at least two types of batteries 3, 4 of different weights. When a heavy large battery 4 is held in (on) the battery mounting part 21, the position of the center of gravity in the front-rear direction of the portable cutting machine 1 having the large battery 4 mounted thereon is shifted closer to the user than the position of the center of gravity in the front-rear direction of the portable cutting machine 1 having the light small battery 3 mounted thereon. Accordingly, since, in ordinary cutting work, the portable cutting machine 1 for woodworking is pushed in the direction away from the user to advance the cutting work, even when the heavy large battery 4 is mounted (used), the portable cutting machine 1 for woodworking is unlikely to fall over toward the user.

In the exemplary embodiment, when the small battery 3 is mounted as shown in FIG. 8, the center of gravity G3 of the main body 20 is located, in the front-rear direction, within the diameter (within the range of thickness or width in the front-rear direction) of the support members 11, 12. In addition, when the large battery 4 is mounted as shown in FIG. 10, the center of gravity G4 of the main body 20 is also located, in the front-rear direction, within the diameter (within the range of thickness in the front-rear direction) of the support members 11, 12. Therefore, regardless of whether the battery 3 or 4 is mounted on the battery mounting part 21, the position of the center of gravity G3 or G4 of the main body 20 that includes the battery 3, 4 is located, in front-rear direction, within the lateral width of the support members 11, 12 in the front-rear direction. Accordingly, manual raising and lowering of the main body 20 can be smoothly performed.

In the exemplary embodiment, the main body 20 comprises an electric motor 40 that rotates a cutter bit 2 and a controller 28 that houses a control board including a control circuit for controlling the operation of the electric motor 40. The controller 28 is disposed above the electric motor 40, oriented so as to be intersected by the motor axis J of the electric motor 40. Accordingly, the controller 28 is disposed in a compact manner in the up-down direction.

In the exemplary embodiment, the portable cutting machine 1 for woodworking has a top dead point adjustment mechanism 13 that restricts (limits) the range of upward movement (top dead point) of the main body 20. A lock nut 36b is provided above the support member 11 as the manipulation member of the top dead point adjustment mechanism 13. When the main body 20 is at the maximumly lowered end position in the downward movement range thereof, the battery 3, 4 mounted on the battery mounting part 21 is located, in the up-down direction, in a region overlapping with the lock nut 36b in the left-right direction. Accordingly, the main body 20 can be lowered to a height at which the battery 3, 4 is located to the lateral side of the lock nut 36b. It is thereby possible to achieve a deeper cutting depth of the cutter bit 2 into the workpiece W, without resulting in (requiring) a larger portable cutting machine 1 for woodworking.

In the exemplary embodiment, the main body 20 has an air inlet 25, used for cooling the electric motor, on the side opposite, in the left-right direction, to the lock nut 36b, which is a manipulation member. Accordingly, external air can be smoothly drawn into the air inlet 25 without being subjected to resistance from the lock nut 36b. The cooling efficiency of the electric motor 40 is thereby enhanced.

In the exemplary embodiment, the battery mounting part 21 includes a mount housing 24 having a structure split into left and right halves, which are butt-joined to each other. Accordingly, the work of assembling the battery mounting part 21 can be facilitated.

In the exemplary embodiment, the portable cutting machine 1 for woodworking has a base 10 that is configured to contact the workpiece W during a woodworking operation. The main body 20 is inseparable from the base 10. Accordingly, the illustrated battery mounting part 21 is only used for a plunge type portable cutting machine 1 for woodworking, in which the main body 20 is vertically movable relative to the base 10 via the left and right support members 11, 12. Therefore, the portable cutting machine 1 for woodworking is directed to a dedicated plunge type cutting machine in which, for example, the main body cannot be separated from the base and replaced with a base for a fixed type that does not have support members for vertical movement.

Various changes can be made to the exemplary embodiment without departing from the present teachings. For example, with regard to the holding orientation (mounting orientation) of the batteries 3, 4, a configuration was illustrated in which the length direction L3, L4 is approximately orthogonal to the imaginary plane K in a plan view, but the length direction may be changed to an orientation intersecting the imaginary plane K in a range of approximately 50 to 90 degrees. In this case, the inclination of the length direction L with respect to the imaginary plane K includes inclinations in any direction, including the up-down and left-right directions. By holding the battery in an orientation angled (oblique) with respect (relative) to the imaginary plane K, shifting of the position of the center of gravity of the main body in the left-right direction is curtailed when interchangeably mounting batteries of different sizes. Good handling is thereby ensured when manually raising and lowering the main body and in maneuvering the portable cutting machine during a woodworking operation.

In addition, by holding the battery angled (oblique) with respect (relative) to the imaginary plane K, the battery is held in a compact manner in a range that does not protrude beyond the left and right support members 11 and 12 in a plan view, and thus it does not get in the way of the user when gripping the grip parts 22 and 23.

Although a configuration was illustrated that is applicable to two types of batteries 3, 4 having the same widths S3, S4, the illustrated holding orientation (an orientation in which the length direction intersects the imaginary plane K within a range of approximately 50 to 90 degrees) can also be applied, for example, to multiple types of batteries having different widths, as long as they do not protrude laterally beyond the left and right support members 11, 12.

Although the illustrated exemplary embodiment illustrates a configuration in which a linear ball bearing 44 is used for (in) the right-side support member 12, it can also be used for (in) the left-side support member 11. It may also be configured to use a sliding bearing instead of a linear ball bearing.

In the exemplary embodiment, a router having grip parts 22, 23 on the left and right was illustrated as an example of a portable cutting machine 1 for woodworking, but the exemplified battery holding orientation can be applied to a trimmer used primarily for relatively light cutting work such as working the edges of wood, usually by being held and moved with one hand.

Although the portable cutting machine for woodworking 1 was illustrated in a mode in which one battery 3 (or battery 4) is mounted on the upper part of the main body 20, the portable cutting machine for woodworking may be configured (adapted) such that, for example, two batteries can be simultaneously mounted (i.e. two battery mounting parts 21 may be provided on the portable cutting machine 1). In this case, a configuration is possible in which one battery is held in the orientation illustrated at the upper part of the main body, and the other one is held, for example, on the base.

Additional aspects of the present teachings include, but are not limited to:

1. A portable cutting machine for woodworking, comprising:
left and right support members, extending vertically, parallel to each other;
a main body, which is vertically movably supported by the support members at a position between the support members, and is biased upward by the biasing force of a compression spring disposed inside a support member, and on which a cutter bit is mounted; and
a battery mounting part, on which one battery is removably mounted above the main body,
wherein the battery mounting part holds the one battery oriented so that the longitudinal direction of the battery is at an angle of 70 to 90 degrees with respect to an imaginary plane that contains the support members.

2. A portable cutting machine for woodworking, comprising:
left and right support members, extending vertically, parallel to each other;
a main body, which is vertically movably supported by the support members at a position between the support members, and is biased upward by the biasing force of a compression spring disposed inside a support member, and on which a cutter bit is mounted;
grip parts provided on both the left and right sides of the main body; and
a battery mounting part, on which one battery is removably mounted above the main body,
wherein the battery mounting part holds the one battery oriented so that the longitudinal direction of the battery is angled with respect to an imaginary plane that contains the support members.

3. The portable cutting machine for woodworking according to the above Aspect 2, wherein the battery mounting part holds the battery oriented so that the longitudinal direction of the battery is angled by 50 degrees or greater with respect to the imaginary plane.

4. The portable cutting machine for woodworking according to the above Aspect 2, wherein the battery mounting part holds the battery oriented so that the longitudinal direction of the battery is angled by 70 degrees or greater with respect to the imaginary plane.

5. The portable cutting machine for woodworking according to the above Aspect 2, wherein the battery mounting part holds the battery oriented so that the longitudinal direction of the battery is angled by approximately 90 degrees with respect to the imaginary plane.

6. The portable cutting machine for woodworking according to any one of the above Aspects 1 to 5, wherein the battery mounting part comprises a receiving opening, which receives the battery, on the user side, and a stopper, which blocks movement of the battery that has been moved through the receiving opening in the direction away from the user.

7. The portable cutting machine for woodworking according to any one of the above Aspects 1 to 6, wherein, when multiple types of batteries of different sizes or weights are interchangeably mounted on the battery mounting part, the position, in the left-right direction, of the center of gravity of the portable cutting machine for woodworking is kept constant.

8. The portable cutting machine for woodworking according to any one of the above Aspects 1 to 7, wherein, when multiple types of batteries of different weights are interchangeably mounted on the battery mounting part, the battery is held on the battery mounting part so that the position of the center of gravity of a heavy battery is shifted toward the user.

9. The portable cutting machine for woodworking according to any one of the above Aspects 1 to 7, wherein, when the battery is mounted on the battery mounting part, the position of the center of gravity of the main body that includes the battery is located on the imaginary plane.

10. The portable cutting machine for woodworking according to any one of the above Aspects 1 to 9, wherein:
the main body comprises an electric motor that rotates the cutter bit and a controller that houses a control board including a control circuit, which controls the operation of the electric motor; and
the controller is disposed above the electric motor, orientated so as to intersect the motor axis of the electric motor.

11. The portable cutting machine for woodworking according to any one of the above Aspects 1 to 10, comprising:
a top dead point adjustment mechanism manipulation member at the upper part of a support member, which restricts the range of upward movement of the main body, and
when the main body is at a maximumly lowered end position in the downward movement range thereof, the battery mounted on the battery mounting part is located, in the up-down direction, in a region overlapping with the manipulation member.

12. The portable cutting machine for woodworking according to the above Aspect 11, wherein the main body has an air inlet used for cooling the electric motor, on the side opposite, in the left-right direction, to the manipulation member.

13. The portable cutting machine for woodworking according to any one of the above Aspects 1 to 12, wherein the battery mounting part includes a housing having a structure split into left and right halves, which are butt-joined to each other.

14. The portable cutting machine for woodworking according to any one of the above Aspects 1 to 13, comprising:
a base that is brought into contact with a workpiece,
wherein the main body is provided inseparably from the base.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved portable cutting machines, including without limitation, routers, etc.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMERALS

1: portable cutting machine for woodworking
W: workpiece
K: imaginary plane
2: cutter bit
3: battery (small)
3a: rail receiving part, 3b: terminal receiving part (positive electrode), 3c: terminal receiving part (negative electrode)
3d: step, 3e: locking hook, 3f: unlocking button
4: battery (large)
4a: rail receiving part, 4b: terminal receiving part (positive electrode), 4c: terminal receiving part (negative electrode)
4d: step, 4e: locking hook, 4f: unlocking button
10: base
10a: work aperture, 10b: joining cylinder
11: support member (left side)
12: support member (right side)
13: top dead point adjustment mechanism
20: main body
21: battery mounting part
21a: receiving opening, 21b: stopper, 21c: elastic body, 21d: rail, 21e: locking recess
22: grip part (left side)
23: grip part (right side)
23a: standby switch, 23b: start switch, 23c: lock-on button
24: mount housing
24a: left mount housing, 24b: right mount housing
25: air inlet
26: speed change (adjustment) dial
27: terminal board
27a: connection terminal (positive electrode), 27b: connection terminal (negative electrode)
28: controller
G3: position of the center of gravity of the main body when the small battery is mounted
G4: position of the center of gravity of the main body when the large battery is mounted
30: main body housing
31: upper housing
31a, 31b: support cylinder
32: lower housing
32a, 32b: support cylinder, 32c: mount (left side), 32d: mount (right)
32e: stopper mount
32f: exhaust port
33, 34: bearing
35: auxiliary housing
36: auxiliary member
36a: male thread, 36b: lock nut (manipulation member), 36c: cap, 36d: auxiliary sleeve
37: compression spring
38: auxiliary member
39: compression spring
40: electric motor
41: motor shaft
J: motor axis
42: cooling fan
43: chuck
44: linear ball bearing
50: bottom dead point stopper
51: stopper screw
52: knob
53: release button
55: stopper receiving part
56, 57, 58: contact part
59: mount

1. A portable cutting machine for woodworking, comprising:
left and right support members, extending in an up-down direction, parallel to each other;
a main body, which is supported by the support members to be movable in the up-down direction relative to the support members and is located at a position between the support members in a left-right direction that is perpendicular to the up-down direction, the main body being biased upwardly by a biasing force of a compression spring disposed inside one of the support members, wherein a cutter bit is mountable on a rotatable shaft protruding downward from the main body in the up-down direction; and
a battery mounting part disposed above the main body in the up-down direction, one battery being removably mountable on the battery mounting part,
wherein the battery mounting part is configured to hold the one battery oriented so that the longitudinal direction of the battery is at an angle of 70 to 90 degrees relative to an imaginary plane that contains the support members, the imaginary plane extending in the up-down direction and the left-right direction.

2. The portable cutting machine for woodworking according to claim 1, wherein the battery mounting part comprises:
a receiving opening, which receives the battery, on a side of the portable cutting machine that will face a user during operation of the portable cutting machine, and
a stopper, which blocks movement of the battery that has been moved through the receiving opening in the direction away from the user.

3. The portable cutting machine for woodworking according to claim 1, wherein the battery mounting part is configured to interchangeably mount multiple types of batteries of different sizes or weights such that the position, in the left-right direction, of the center of gravity of the portable cutting machine is constant regardless of the battery that is mounted.

4. The portable cutting machine for woodworking according to claim 1, wherein the battery mounting part is configured to interchangeably mount multiple types of batteries of different weights such that the position in a front-rear direction of the center of gravity of the main body having a heavier battery mounted on the battery mounting part is shifted closer to a user, who is operating the portable cutting machine, than the position in a front-rear direction of the center of gravity of the main body having a lighter battery mounted on the battery mounting part, the front rear-direction being perpendicular to the up-down direction and the left-right direction.

5. The portable cutting machine for woodworking according to claim 1, wherein, in a state in which the battery is mounted on the battery mounting part, the position in the front-rear direction of the center of gravity of the main body is located in the imaginary plane.

6. The portable cutting machine for woodworking according to claim 1, wherein:
the main body comprises an electric motor configured to rotate the cutter bit and a controller that houses a control board including a control circuit, which is configured to control operation of the electric motor; and
the controller is disposed above the electric motor in the up-down direction, and is orientated so that a motor axis of the electric motor intersects the controller.

7. The portable cutting machine for woodworking according to claim 1, further comprising:
a manipulation member of a top dead point adjustment mechanism disposed at an upper part of one of the support members in the up-down direction, the top dead point adjusting mechanism being configured to restrict the range of upward movement of the main body relative to the support members, and
wherein the portable cutting machine is configured such that, when the main body is at a maximumly lowered end position in the downward movement range thereof, the battery mounted on the battery mounting part is located, in the up-down direction, in a region overlapping with the manipulation member in the left-right direction.

8. The portable cutting machine for woodworking according to claim 7, wherein the main body has an air inlet configured to draw in external air for cooling the electric motor, on the side opposite, in the left-right direction, to the manipulation member.

9. The portable cutting machine for woodworking according to claim 1, wherein the battery mounting part includes a housing having a structure split into left and right halves, which are butt-joined to each other.

10. The portable cutting machine for woodworking according to claim 1, further comprising:
a base configured to contact a workpiece during a woodworking operation,
wherein the main body is inseparable from the base.

11. The portable cutting machine for woodworking according to claim 2, wherein the battery mounting part is configured to interchangeably mount multiple types of batteries of different sizes or weights such that the position, in the left-right direction, of the center of gravity of the portable cutting machine is constant regardless of the battery that is mounted.

12. The portable cutting machine for woodworking according to claim 11, wherein the battery mounting part is configured to interchangeably mount multiple types of batteries of different weights such that the position in a front-rear direction of the center of gravity of the main body having a heavier battery mounted on the battery mounting part is shifted closer to the user, who is operating the portable cutting machine, than the position in a front-rear direction of the center of gravity of the main body having a lighter battery mounted on the battery mounting part, the front rear-direction being perpendicular to the up-down direction and the left-right direction.

13. The portable cutting machine for woodworking according to claim 12, wherein:
the main body comprises an electric motor configured to rotate the cutter bit and a controller that houses a control board including a control circuit, which is configured to control operation of the electric motor; and
the controller is disposed above the electric motor in the up-down direction, and is orientated so that a motor axis of the electric motor intersects the controller.

14. The portable cutting machine for woodworking according to claim 13, further comprising:
a manipulation member of a top dead point adjustment mechanism disposed at an upper part of one of the support members in the up-down direction, the top dead point adjusting mechanism being configured to restrict the range of upward movement of the main body relative to the support members, and
wherein the portable cutting machine is configured such that, when the main body is at a maximumly lowered end position in the downward movement range thereof, the battery mounted on the battery mounting part is located, in the up-down direction, in a region overlapping with the manipulation member in the left-right direction.

15. The portable cutting machine for woodworking according to claim 14, further comprising:
a base configured to contact a workpiece during a woodworking operation,
wherein the main body is inseparable from the base.

16. A portable cutting machine for woodworking, comprising:
left and right support members, extending in an up-down direction, parallel to each other;
a main body, which is supported by the support members to be movable in the up-down direction relative to the support members and is located at a position between the support members in a left-right direction that is perpendicular to the up-down direction, the main body being biased upwardly by the biasing force of a compression spring disposed inside one of the support members, wherein a cutter bit is mountable on a rotatable shaft protruding downward from the main body in the up-down direction;
grip parts respectively provided on left and right sides of the main body in the left-right direction; and
a battery mounting part disposed above the main body in the up-down direction, one battery being removably mountable on the battery mounting part,
wherein the battery mounting part is configured to hold the one battery oriented so that the longitudinal direction of the battery is angled relative to an imaginary plane that contains the support members, the imaginary plane extending in the up-down direction and the left-right direction.

17. The portable cutting machine for woodworking according to claim 16, wherein the battery mounting part is configured to hold the battery oriented so that the longitudinal direction of the battery extends at an angle of 50 degrees or greater relative to the imaginary plane.

18. The portable cutting machine for woodworking according to claim 16, wherein the battery mounting part is configured to hold the battery oriented so that the longitudinal direction of the battery extends at an angle of 70 degrees or greater relative to the imaginary plane.

19. The portable cutting machine for woodworking according to claim 16, wherein the battery mounting part is configured to hold the battery oriented so that the longitudinal direction of the battery extends at an angle of approximately 90 degrees relative to the imaginary plane.

20. The portable cutting machine for woodworking according to claim 16, wherein the battery mounting part is configured to interchangeably mount multiple types of batteries of different sizes or weights such that the position, in the left-right direction, of the center of gravity of the portable cutting machine is constant regardless of the battery that is mounted.
